(19) United States
(12) Patent Application Publication
(10) Pub. No.: US 2013/0239754 A1
(43) Pub. Date: Sep. 19, 2013

(54) SQUEEZING HEAD TORQUE TOOL

(71) Applicants: Dale Francis, Luling, LA (US); Nic Francis, Luling, LA (US); William P. Bernard, Luling, LA (US); Oswald J. Bernard, Luling, LA (US); Patrick V. Delbasty, Luling, LA (US)

(72) Inventors: Dale Francis, Luling, LA (US); Nic Francis, Luling, LA (US); William P. Bernard, Luling, LA (US); Oswald J. Bernard, Luling, LA (US); Patrick V. Delbasty, Luling, LA (US)

(73) Assignee: FRANCIS TORQ/LITE, INC., Luling, LA (US)

(21) Appl. No.: 13/568,217

(22) Filed: Aug. 7, 2012

Related U.S. Application Data
(60) Provisional application No. 61/611,791, filed on Mar. 16, 2012.

(51) Int. Cl. B25B 13/50; B25B 13/46

(52) U.S. Cl. 81/57.44; 81/58.2

(57) ABSTRACT

A uniquely designed torque wrench having a torque body, the torque body attached to a drive head, the drive head entering a contracted stated during extension of a rod of a hydraulic cylinder, and entering an expanded state during the retraction of the rod of a hydraulic cylinder.

### CROSS-REFERENCE TO RELATED APPLICATIONS

This is a non-provisional application of U.S. provisional application Ser. No. 61/611,791, filed Mar. 16, 2012, priority of which application is hereby claimed and which application is incorporated herein by reference.

### BACKGROUND

In one embodiment, the method and apparatus relate to torque tools. More particularly, in one embodiment is provided a method and apparatus wherein a ratcheting hydraulic torque wrench is used for tightening and loosening irregularly shaped items (e.g., non-nuts such as cylindrically or oblong shaped items which where a drive head frictionally connects to the item to be loosened or tightened providing a turning torque, and the amount of force of the frictional connects varies directly with the amount of turning torque provided by the wrench.

In one embodiment the torque wrench is provided with a head having a gate that can be opened allowing the drive head to be connected to the item to be tightened or loosened along the longitudinal axis of the item. After the drive head is placed on the item it can be placed in a locked condition allowing the frictional drive mechanism to be engaged.

One prior art wrench is the type shown in U.S. Pat. No. 6,279,427 titled “Crosshead Jam Nut Torque Wrench, which is incorporated herein by reference, and discloses a gated drive head. However, such gated drive head does not provide a frictional driving force which varies directly with the amount of turning torque supplied by the wrench. Also incorporated herein by reference is U.S. Pat. No. 5,097,730.

While certain novel features of this invention shown and described below are pointed out in the annexed claims, the invention is not intended to be limited to the details specified, since a person of ordinary skill in the relevant art will understand that various omissions, modifications, substitutions and changes in the forms and details of the device illustrated and in its operation may be made without departing in any way from the spirit of the present invention. No feature of the invention is critical or essential unless it is expressly stated as being “critical” or “essential.”

### BRIEF SUMMARY

In one embodiment is provided torque wrench having a wrench body, the wrench body rotationally attached to squeezing frictional drive head, with the drive head having an expanding and contracting opening, for fitting over an item to be tightened or loosened, such as a joint of tubing or pipe wherein the drive head can enter a squeezing state and non- squeezing states. In one embodiment the squeezing and non-squeezing states are based on the direction of turn of the drive head relative to the torque body, with opposite relative rotations providing opposite squeezing states—squeezing versus non-squeezing.

In one embodiment is provided a hydraulic cylinder secured between the wrench body and the squeezing drive head so that under hydraulic pressure, the head is both rotated and caused to squeeze causing frictional forces to be created between the squeezing drive head and the item to be tightened or loosened. In one embodiment the frictional forces create sufficient forces to rotate to the item to be tightened or loosened.

In one embodiment is provided a hydraulic cylinder secured between the wrench body and the squeezing drive head so that under hydraulic pressure, the head is both rotated and caused to enter a squeezing state such squeezing state causing increased frictional forces to be created (relative to a non-squeezing state) between the squeezing drive head and the item to be tightened or loosened. In one embodiment the frictional forces create sufficient torsional forces to rotate to the item to be tightened or loosened.

In one embodiment the drive head can comprise first and second portions which are pivotally connected to each other at a first end, and a turning torque placed on the first portion tends to cause the first portion to rotate in a first direction, a torque is also placed on the second portion tending to cause the second portion to rotate in a second direction, the second direction being in substantially the opposite direction as the first direction.

In one embodiment the drive head can be provided with a gate portion which can be disengaged and opened, to define a gate which can allow item to be tightened or loosened to be positioned inside the interior of the drive head while the drive head remains between the longitudinal ends of the item to be tightened or loosened. The item to be tightened or loosened can be positioned within the interior of the open drive head, and the gate portion of the drive head placed in a squeezing state forming a frictionally squeezing drive head.

In one embodiment is provided a fluid powered torque wrench having

(a) a torque body;

(b) a drive head rotationally connected to the torque body;

(c) a fluid cylinder operatively connected to the drive head and the torque body;

(d) with the drive head having a relaxed state with an opening of a first size, for fitting over an item to be tightened or loosened such as a joint of tubing or pipe,

(e) wherein the fluid cylinder during the process of causing rotation of the drive head in a first direction causes the drive head to enter a squeezing state wherein the opening reduces to a second size which is smaller than the first size, thereby causing frictional forces between the drive head and the item to be tightened or loosened during turning in the first direction, and

(f) wherein the fluid cylinder in the process of causing rotation of the drive head in a second direction, which second direction is the opposite direction of the first direction, causes the drive head to enter a relaxed state wherein the frictional forces between the drive head and the item to be tightened or loosened are substantially reduced in relation to the frictional forces generated during the squeezing state.

In one embodiment is provided a fluid powered torque wrench having

(a) a torque body;

(b) a drive head rotationally connected to the torque body;

(c) a fluid cylinder operatively connected to the drive head and the torque body;

(d) with the drive head having a relaxed state with an opening of a first size, for fitting over an item to be tightened or loosened such as a joint of tubing or pipe,

(e) wherein the fluid cylinder during the process of causing rotation of the drive head in a first direction causes the drive head to enter a squeezing state wherein the opening reduces to a second size which is smaller than the first size, thereby causing frictional forces between the drive head and the item to be tightened or loosened during turning in the first direction, and

(f) wherein the fluid cylinder in the process of causing rotation of the drive head in a second direction, which second direction is the opposite direction of the first direction, causes the drive head to enter a relaxed state wherein the opening is of a larger size than the second size.

In one embodiment, the drive head, rotationally connected to the torque body, can comprise a four bar linkage mechanism comprising a fulcrum, link, first section, and second section wherein the first and second sections are pivotally connected to each other, the link is pivotally connected to the first section and fulcrum, and the fulcrum is pivotally connected to the second section. In one embodiment fluid rod/cylinder can be pivotally connected to fulcrum and wrench body. In one embodiment extension of rod relative to cylinder will cause the drive head to enter a contracting state and also cause rotation of drive head relative to wrench body in a first direction. In one embodiment retraction of rod relative to cylinder will cause the drive head to enter an expanding state (causing relative expansion of the cross sectional size of the interior space of drive had) and also cause rotation of drive head relative to wrench body in the second direction which is the opposite of the first direction, and also cause drive head to slide relative to item to be loosened or tightened (i.e., not turn item during a retraction stroke of rod relative to cylinder). In one embodiment such relative expansion of interior space limited/restricted to a maximum extent. In one embodiment during a retraction stroke, the maximum amount of relative expansion of interior space during an expansion stroke in percent area (compared to the cross sectional area of interior space's 395 size during extension stroke of rod 1100 ) is about 1, 2, 3, 4, 5, 6, 7, 8, 9, 10, 12, 14, 15, 16, 18, 20, 22, 24, 25, 26, 28, 30, 32, 34, and 35 percent. In various embodiments the maximum amount of relative expansion is between about any two of the above specified relative percentages.

In one embodiment the cross sectional area of the interior can be defined by the area circumscribed by the interior portions of the first and second sections of the drive head. Because there may be a gap between the ends of the interior portions of first and second sections of the drive head (such as when in an expanded state), the area circumscribed can be determined by extrapolating the end of the interior portion of the first section of the drive head onto the end of the interior portion of the second section of the drive head. Such extrapolation can be by a method of curve fitting such as using standard curve fitting (e.g., the best fit curve fit) considering the shape of the interior portion of the first section of the drive head and the shape of the interior portion of the second section of the drive head. Alternatively a straight line can be drawn between the ends of the interior portion of the first and second sections of the drive head.

In one embodiment, during a retraction stroke of rod relative to cylinder, the four bar linkage mechanism of drive head formed by lever fulcrum, link, first section, and second section will cause lever fulcrum to rotate relative to drive head (and relative to second section) causing interior space of drive head to enter an expanding state, and during extension of rod relative to cylinder, lever fulcrum will rotate in the opposite direction (compared to retraction of rod relative to cylinder) causing drive head to enter a contracted state. In one embodiment the maximum sweep (relative to drive head) of lever fulcrum during retraction and extension strokes of rod relative to cylinder in degrees about 1, 2, 3, 4, 5, 6, 7, 8, 9, 10, 12, 14, 15, 16, 18, 20, 22, 24, 25, 26, 28, 30, 32, 34, and 35 degrees. In various embodiments the maximum amount of relative rotation of lever fulcrum 600 is between about any two of the above specified relative degree measurements.

In one embodiment during an extension stroke of rod relative to cylinder, the drive head has a maximum extension stroke area of contact with item to be tightened or loosened, and during a retraction stroke of rod relative to cylinder, drive head has a minimum retraction stroke area of contact with item 1300. In one embodiment the maximum extension stroke area of contact is greater than the minimum retraction stroke area of contact. In various embodiments the extension stroke maximum area of contract is at least 1.1, 1.2, 1.3, 1.4, 1.5, 1.75, 2, 2.25, 2.5, 2.75, 3, 4, 5, 10, 15, 20, 25, 30, 35, 40, 45, and 50 times the retraction stroke minimum area of contact. In various embodiments the ratio of these to areas is between any two of the above specified ratio measurements.

In one embodiment, during a retraction stroke of rod relative to cylinder, the four bar linkage mechanism of drive head (formed by fulcrum, link; first section, and second section) will enter an expanding state where rotation of first section relative to second section about pivot point occurs in the opposite direction of rotation of the drive head during retraction. In one embodiment such relative expanding relative rotation between first section and second section is limited/restricted to a maximum extent. In one embodiment during a retraction stroke of rod relative to cylinder, the maximum amount of relative rotation between first section and second section in degrees is about 1, 2, 3, 4, 5, 6, 7, 8, 9, 10, 12, 14, 15, 16, 18, 20, 22, 24, 25, 26, 28, 30, 32, 34, and 35 degrees. In various embodiments the maximum amount of relative rotation is between about any two of the above specified relative degree measurements. In one embodiment before reaching any maximum amount of relative rotation between first section and second section (with respect to the four bar link system), the increasing reaction forces arising from fulcrum lever attempting to expand first section relative to second section increase to such an extent that frictional forces between track and arcuate slot (along with possible frictional forces between first section and/or second section relative to item to be tightened or loosened) are overcome allowing drive head to rotate/ratchet back into an initial starting drive position to be ready for the next extension stroke of rod relative to cylinder.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a side view of one embodiment showing the wrench mounted on an item to be loosened.

FIGS. 1-5 show various sequences of using the wrench of FIG. 1 to loosen a pipe, wherein FIGS. 2 and 3 sequentially show extension of the hydraulic cylinder, and FIGS. 4 and 5 sequentially show retraction of the hydraulic cylinder.

FIG. 6 shows the wrench of FIG. 2 being placed on a pipe to loosen or unscrew such pipe from a threaded connection.

FIG. 7 shows the wrench of FIG. 2 being placed on a pipe to tighten or screw in such pipe to a threaded connection.

FIG. 8 is an exploded perspective view of the components of the wrench of FIG. 1.

FIGS. 9-13 are various views of the body of the wrench of FIG. 1.

FIGS. 14, 15, and 16 are respectively perspective, front and rear views of the fulcrum lever for the wrench of FIG. 1.

FIGS. 17-21 are perspective views of the first and second sections of the drive head of the wrench of FIG. 1.

FIG. 22 is a perspective view of the drive head of the wrench of FIG. 1 showing first and second sections along with the clamping/squeezing mechanism shown in a non- squeezing state, wherein the drive head is positioned to loosen an item.

FIG. 23 is a front perspective view of the drive head of the wrench of FIG. 1 showing first and second sections along with the clamping/squeezing mechanism.

FIG. 24 is a rear perspective view of the drive head of the wrench of FIG. 1 showing first and second sections along with the clamping/squeezing mechanism.

FIG. 25 is a perspective view of the drive head of the wrench of FIG. 1 showing the first and second sections along with the clamping/squeezing mechanism shown in a squeezing state, wherein the drive head is positioned to loosen an item.

FIG. 26 is a perspective view of the drive head of the wrench of FIG. 1 showing the first and second sections along with the clamping/squeezing mechanism shown in a non- squeezing state, wherein the drive head is positioned to tighten an item.

FIG. 27 is a perspective view of the drive head of the wrench of FIG. 1 showing the first and second sections along with the clamping/squeezing mechanism shown in a squeezing state and with an item to be tightened positioned in the interior of the drive head.

FIGS. 28 and 29 are schematic diagrams of the four bar linkage system for the squeezing drive head of the wrench of FIG. 1 shown respectively in expanded and squeezed or compressed states.

FIG. 30 is a force diagram of the wrench of FIG. 1.

FIG. 31 shows an alternative embodiment of the wrench of FIG. 1, wherein the drive head includes one or more frictionally enhancing elements.

### DETAILED DESCRIPTION OF THE INVENTION

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate system, structure or manner.

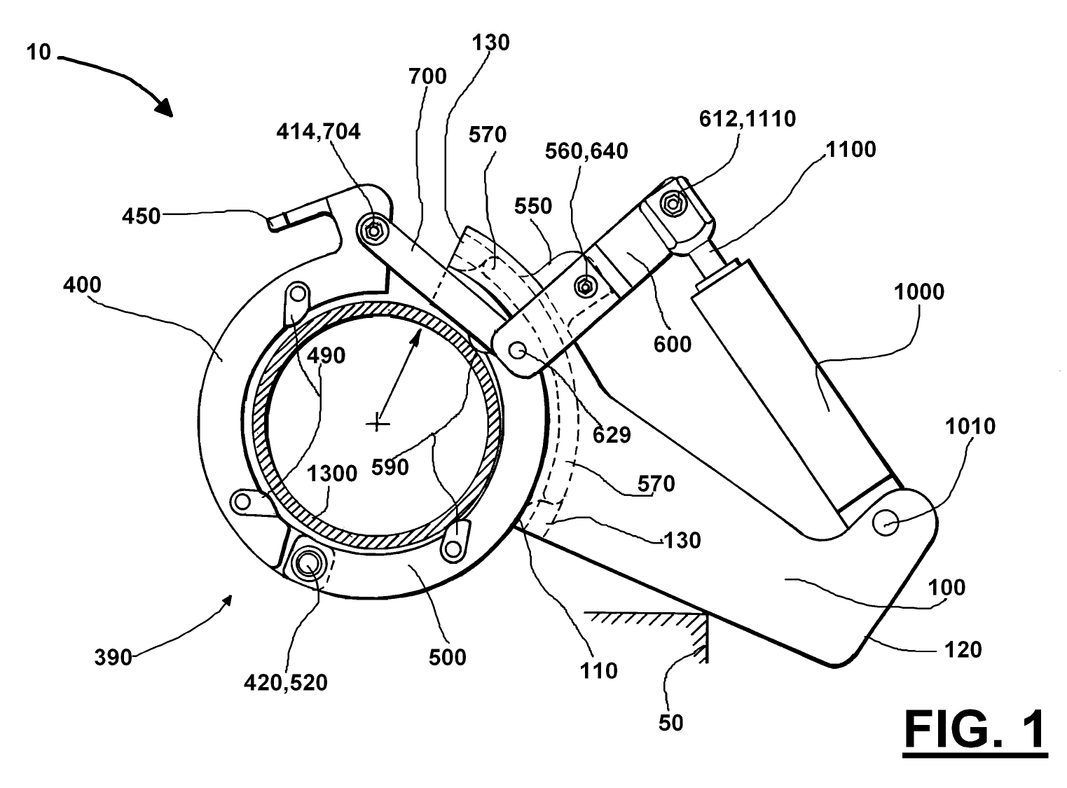

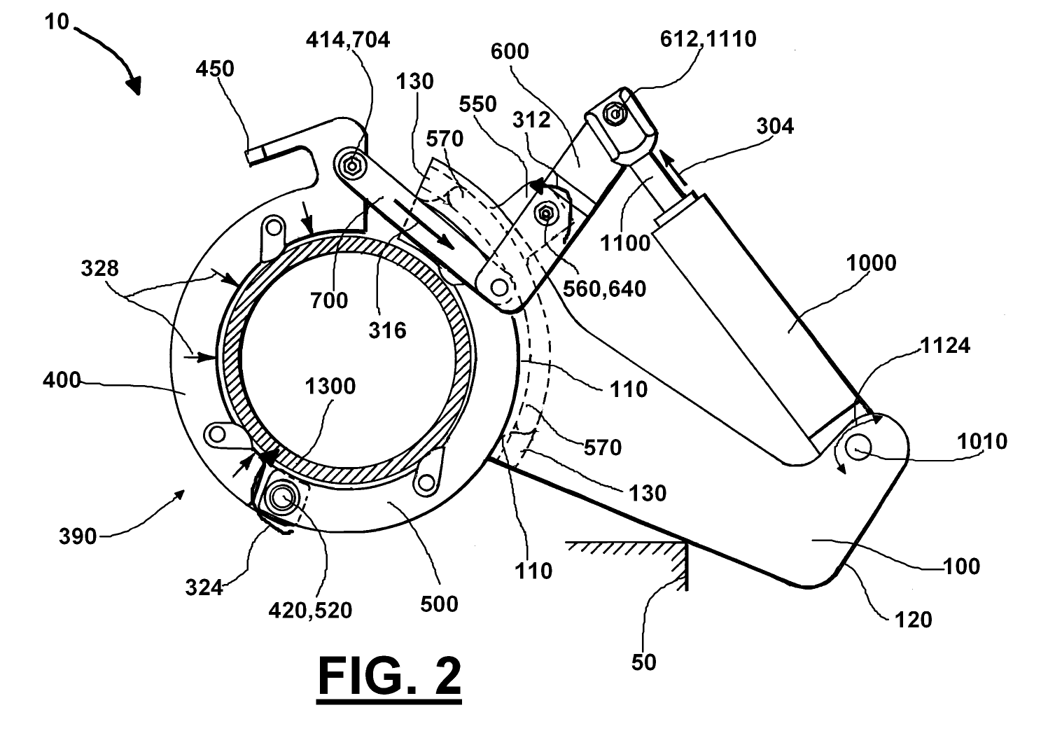

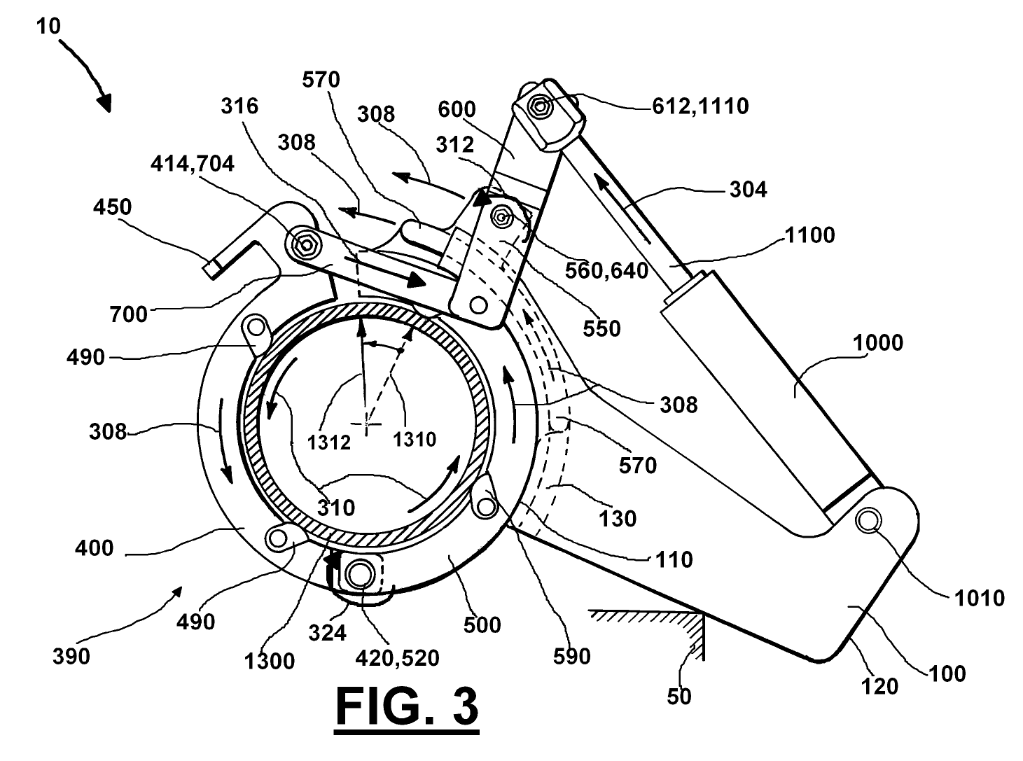

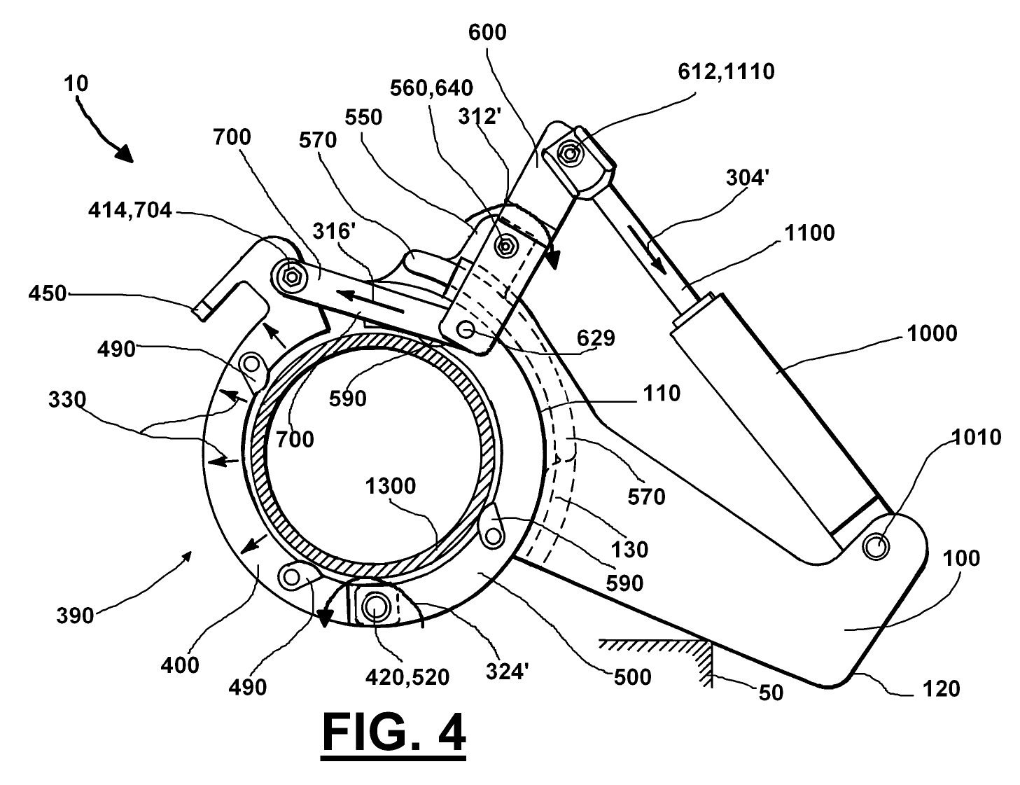

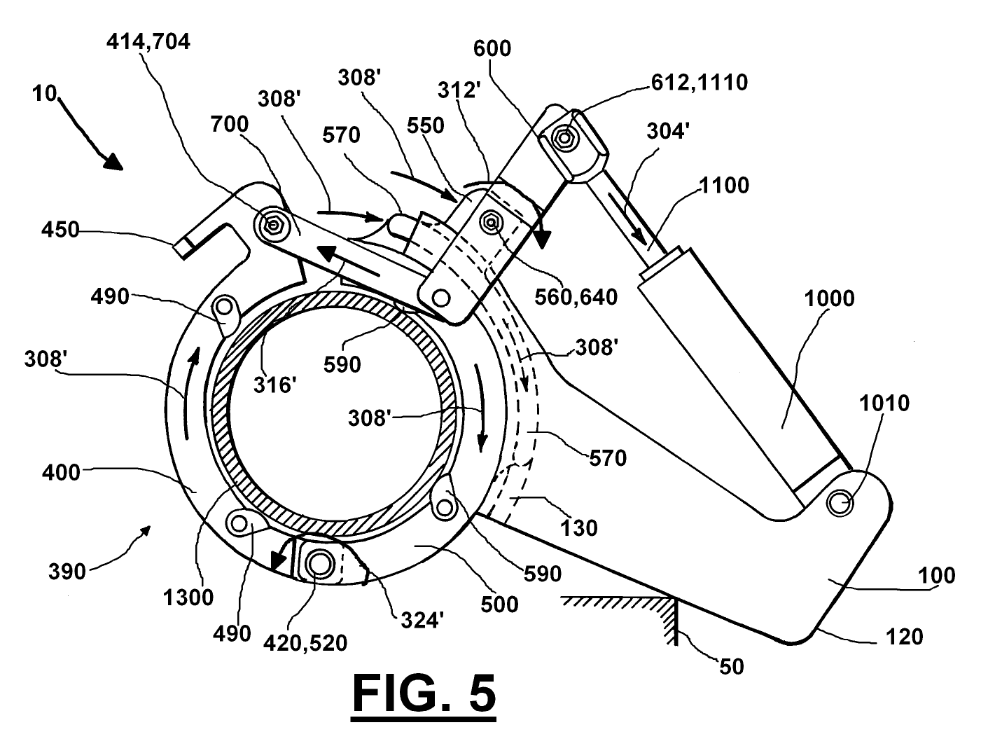

FIG. 1 is a side view of one embodiment showing the wrench 10 mounted on an item 1300 to be loosened. FIGS. 1-5 show various sequences of using wrench 10 to loosen a pipe 1300, wherein FIGS. 2 and 3 sequentially show extension (schematically indicated by arrow 304) of the hydraulic cylinder 1000, and FIGS. 4 and 5 sequentially show retraction (schematically indicated by arrow 304′) of the hydraulic cylinder 1000.

FIGS. 1-3 show various sequences of using wrench 10 to loosen a pipe 1300. In FIG. 1 rod 1100 is fully retracted. In FIG. 2, rod 1100 is partially extended. In FIG. 3, rod 1100 is almost fully extended.

FIGS. 4, 5, and then 1 show various sequences of using wrench 10 to tighten a pipe 1300. In FIG. 1 rod 1100 is fully retracted. In FIG. 4, rod 1100 is beginning to retract. In FIG. 5, rod 1100 is continuing to retract. In FIG. 1 rod 1100 is fully retracted, and is now fully retracted and ready for the next extension cycle.

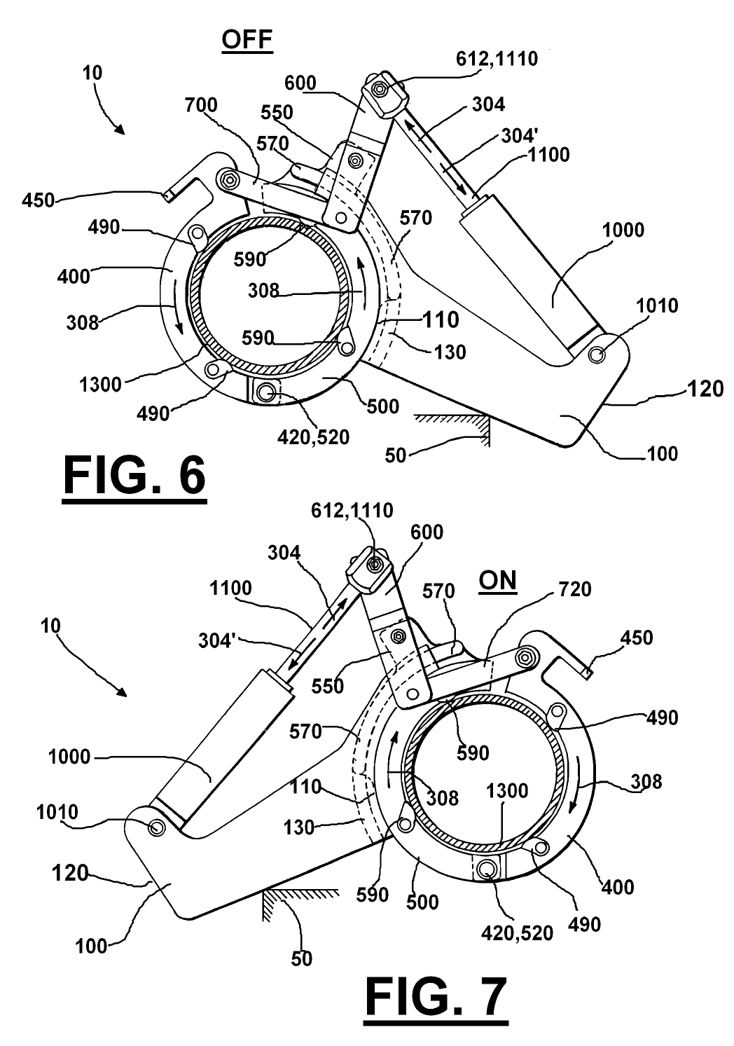

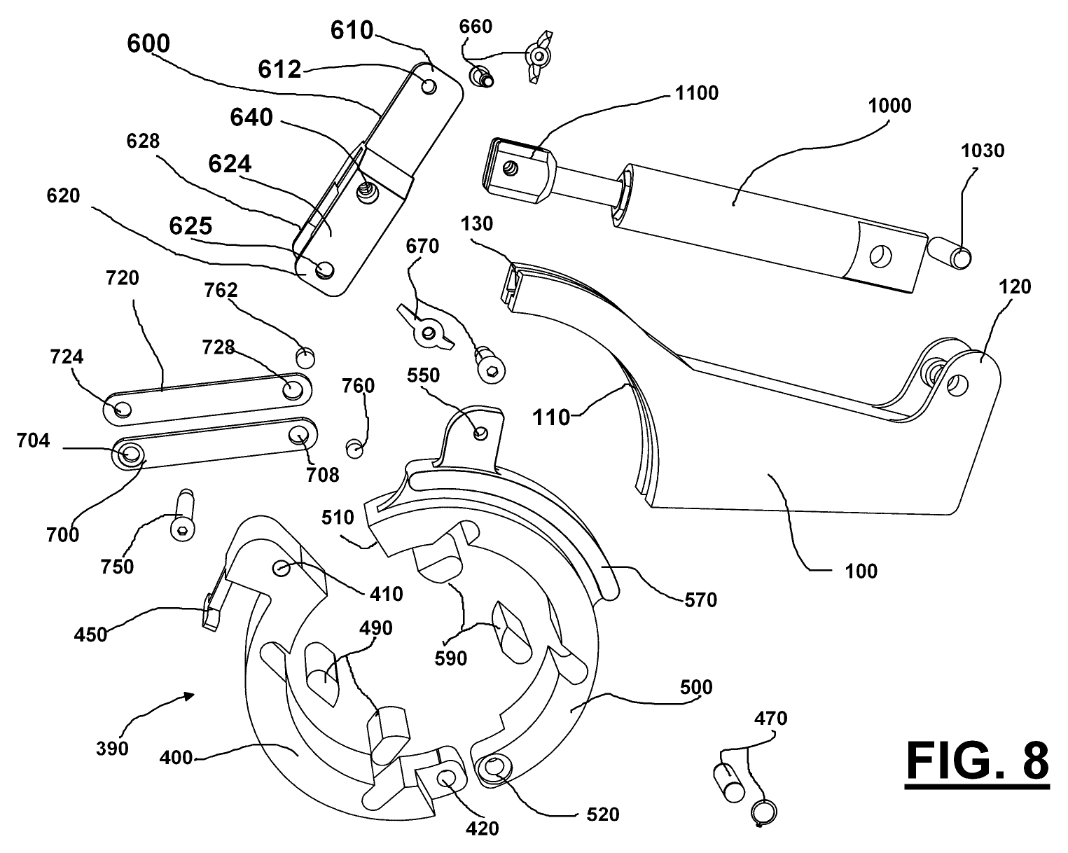

FIG. 6 shows wrench 10 being placed on a pipe 1300 to loosen or unscrew such pipe from a threaded connection. FIG. 7 shows wrench 10 being placed on a pipe 1300 to tighten or screw in such pipe to a threaded connection. A user can place wrench 10 on an item in the desired configuration to loosen or tighten such item. FIG. 8 is an exploded perspective view of the major components of wrench 10.

Generally, torque wrench 10 can include a wrench body 100 having a cooperating drive head portion 390 on a first end 110 and a rear body portion on its second end 120. Wrench body 100 can also include a hydraulic cylinder 1000 and piston rod 1100 for providing reciprocating motive force between body 100 and drive head 390.

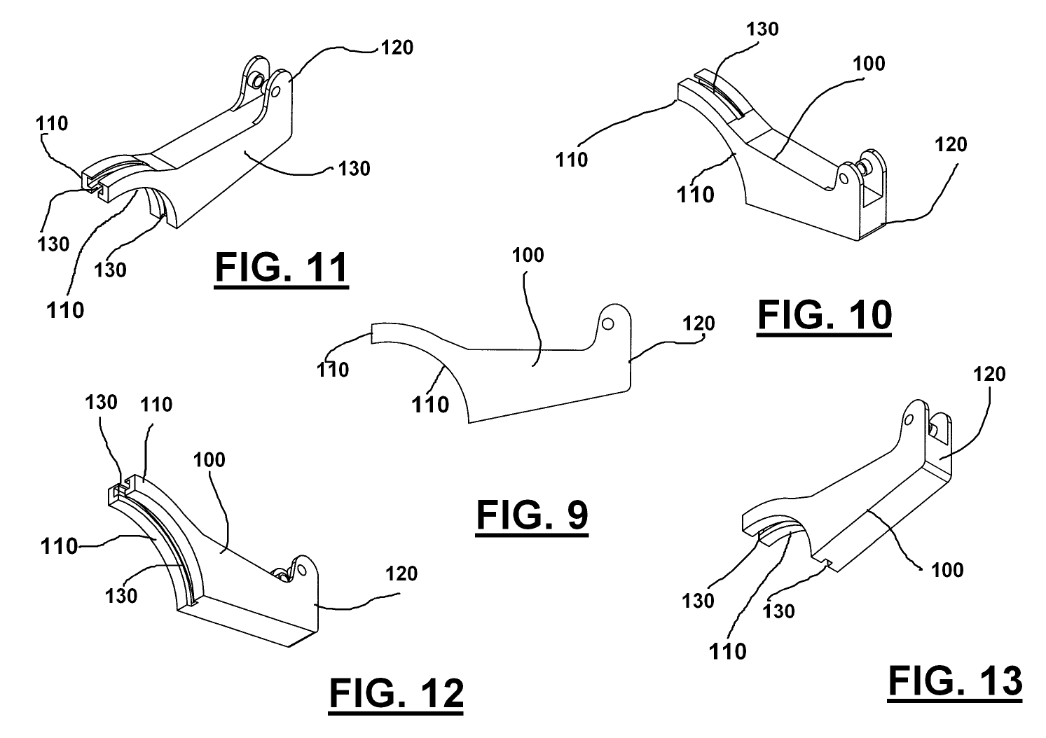

FIGS. 9-13 are various views of the body 100 of wrench 10. Body 100 can comprise first end 110, second end 120, and generally arcuate slot 130.

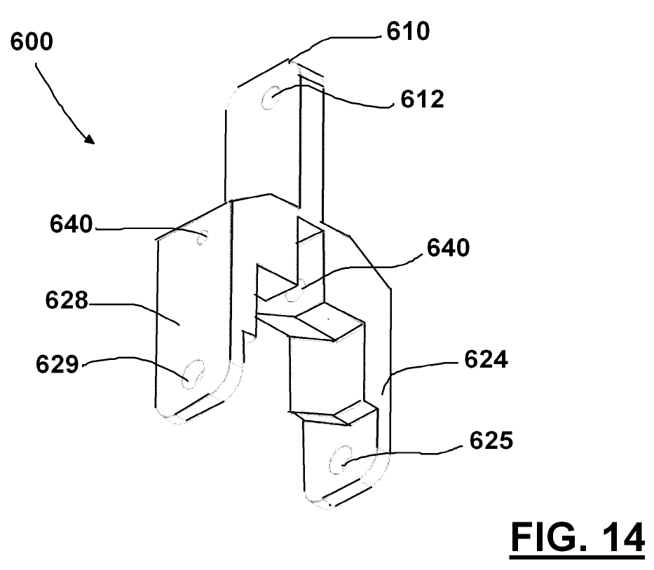

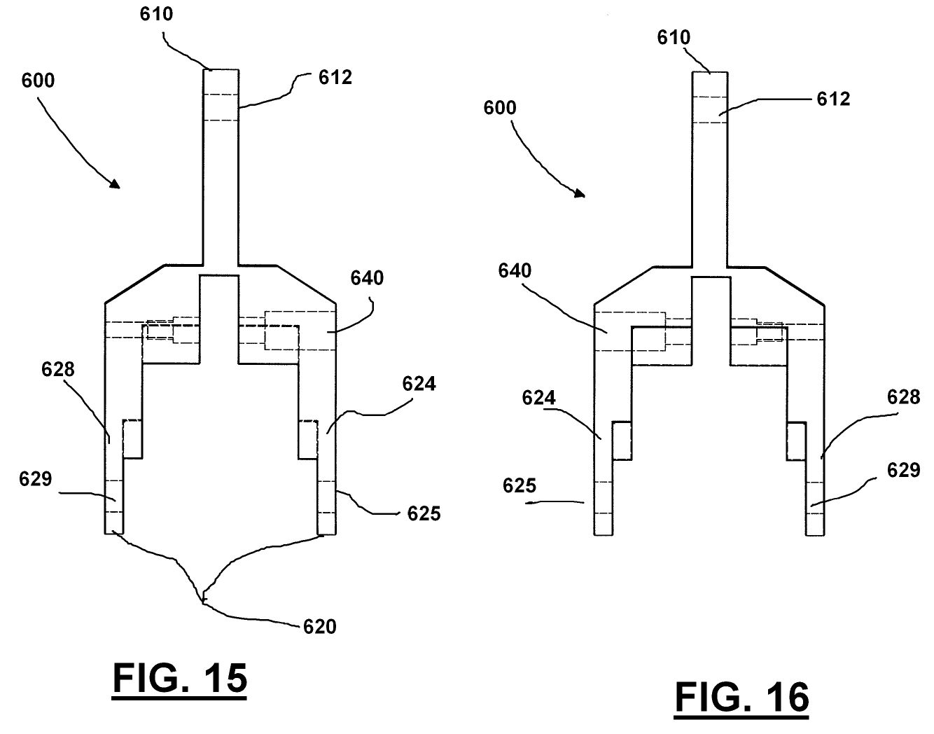

FIGS. 14, 15, and 16 are respectively perspective, front and rear views of the fulcrum lever 600 for wrench 10. Fulcrum lever 600 can comprise first end 610, second end 620 with first and second prongs 624,628 spanning the second end 620. On first end can be pivot point/opening 612. On first and second prongs 624,628 can be pivot points/openings 625,628. Between opening 612 and openings 625,629 can be pivot point/opening 640.

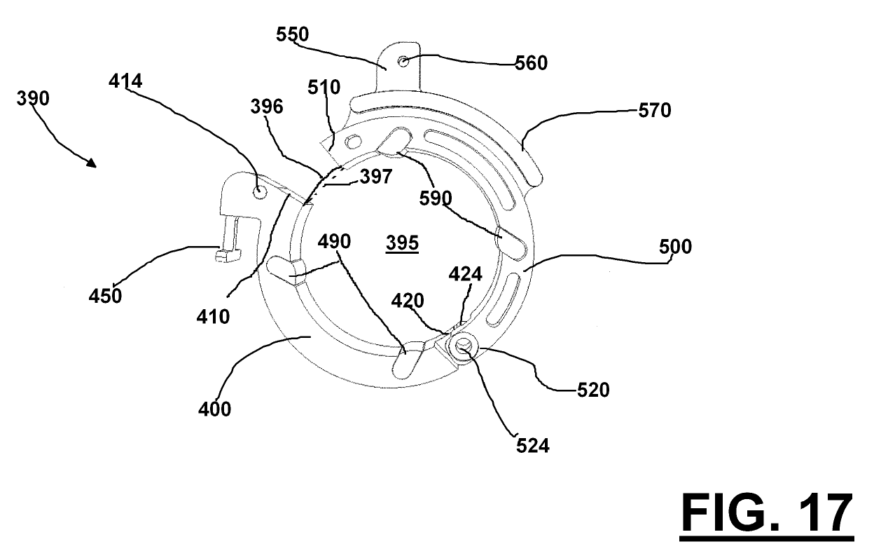

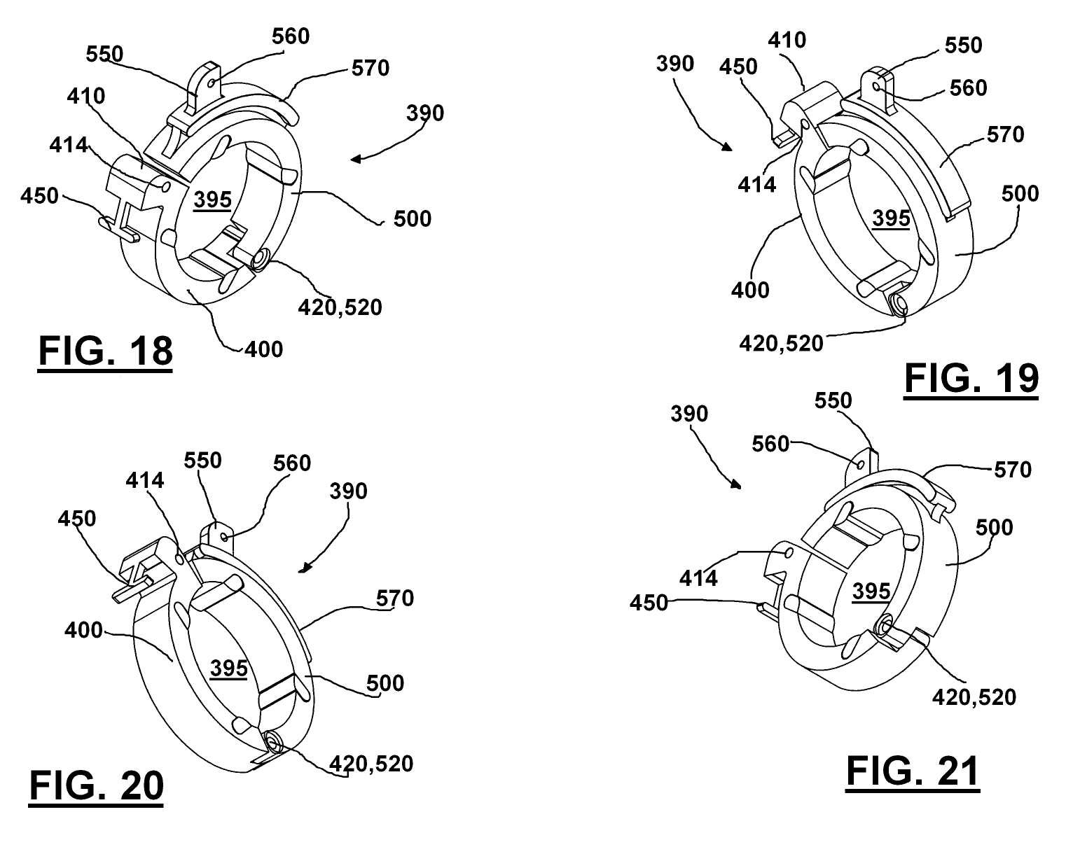

FIGS. 17-21 are perspective views of the first 400 and second 500 sections of drive head 390. First section 400 can comprise first end 410 with pivot point/opening 414, second end 420 with pivot point/opening 424, and handle 450. Second section 500 can comprise first end 510, second end 520 with pivot point/opening 524, track 570, and arm 550 with pivot point/opening 560. Pivot point 424 can be pivotally connected to pivot point 524.

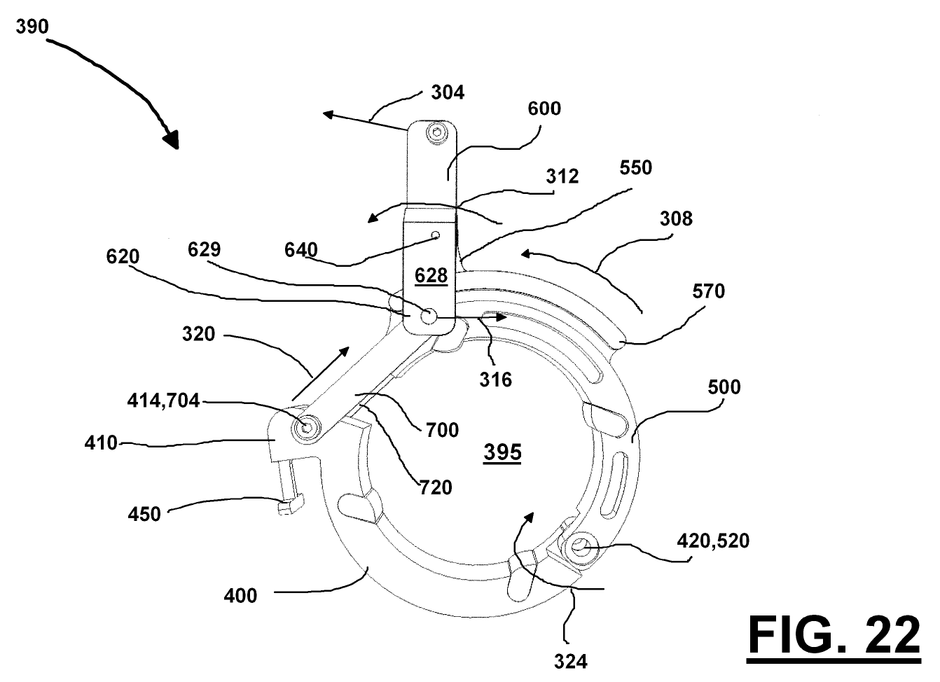

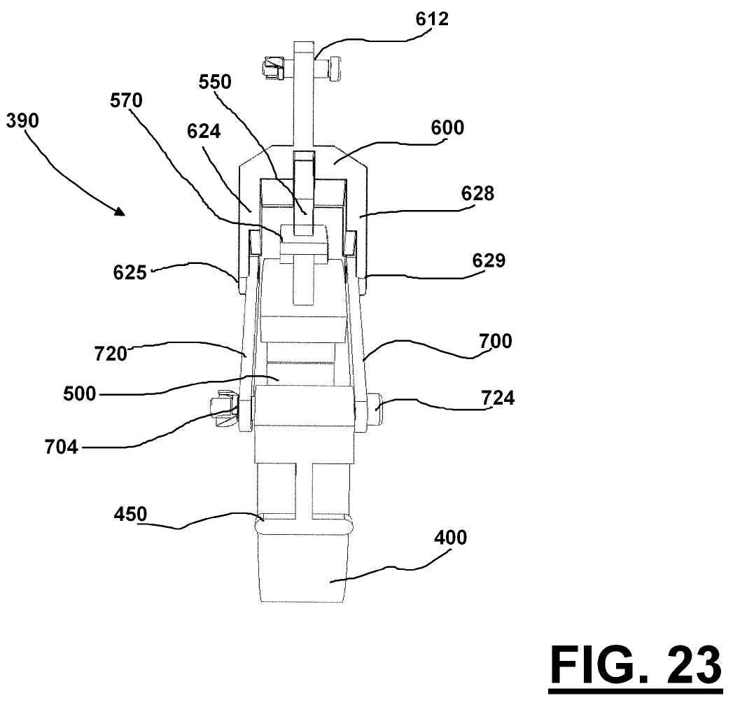

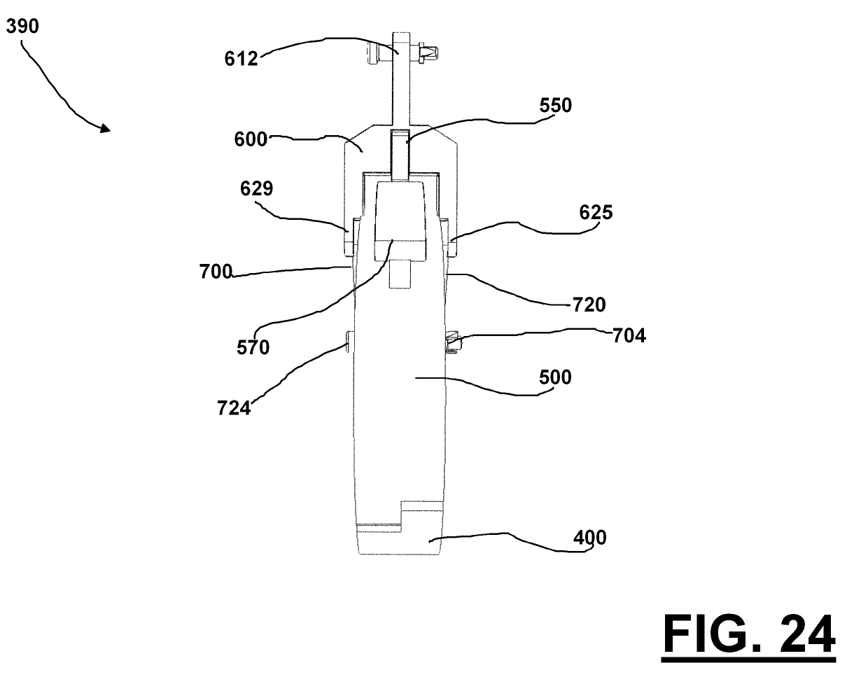

FIG. 22 is a perspective view of drive head assembly 390 of wrench 10 showing first 400 and second 500 sections along with the clamping/squeezing mechanism (lever 600 with links 700,720) shown in anon-squeezing state, wherein the drive head 390 is positioned to loosen an item 1300 (item 1300 is not shown in FIG. 16 however). FIGS. 23 and 24 are respectively front and rear perspective views of drive head 390 showing first 400 and second 500 sections along with the clamping/squeezing mechanism.

Drive head 390 can comprise first section 400, second section 500 pivotally connected to first section 400, and fulcrum lever 600 which is pivotally connected to second section 500 via arm 550 and pivot point 640, and pivotally connected to first section 400 through pivoting links 700,720. In one embodiment squeezing head 390 comprises first section 400, second section 500, fulcrum lever 600, and at least one link 700 (preferably with second link 720). Preferably first 400 and second 500 sections are arcuate in shape. First section 400 can be pivotally connected to second section 500, and when connected define an expandable and shrinkable interior space 395. Fulcrum lever 600 can be pivotally connected to arm 550 of second section 500. Links 700 and 720 can be pivotally connected to first section 400 at first end 410 through opening 414, and also be pivotally connected to fulcrum lever 600 at second end 620 respectively at openings 628 and 625. In this manner of connection fulcrum 600, links 700,720; first section 400, and second section 500 form a four bar linkage system allowing drive head to have shrinking and expanding interior space 395 with the fulcrum lever 600 being the driving link.

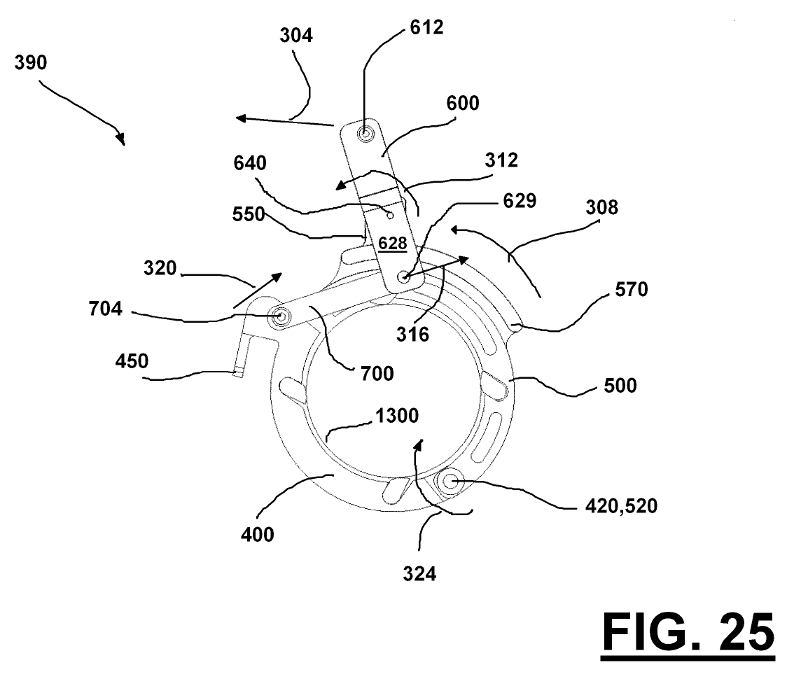

FIG. 25 is a perspective view of the drive head 390 showing the first 400 and second 500 sections along with the clamping/squeezing mechanism shown in a squeezing state, wherein the drive head 390 is positioned to loosen an item 1300.

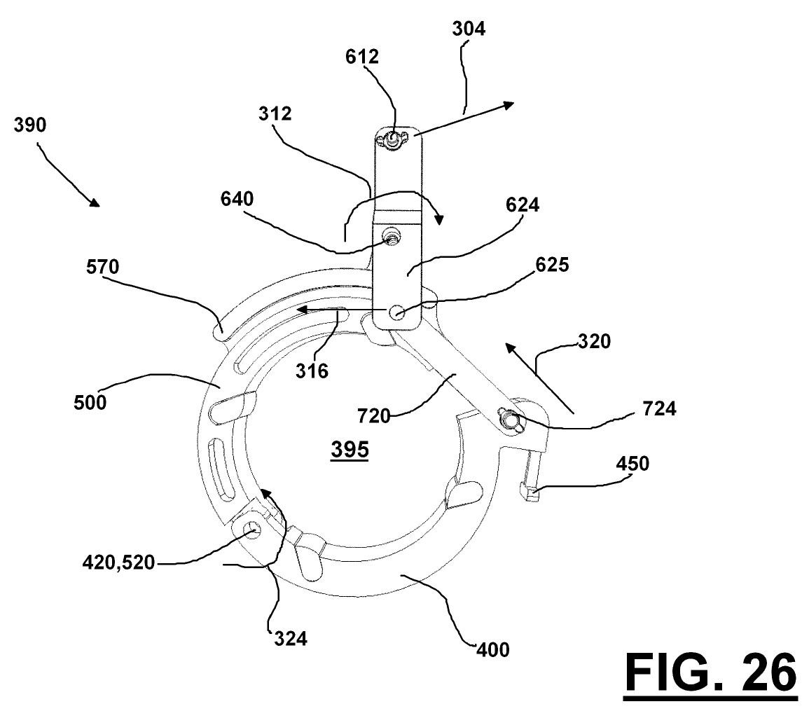

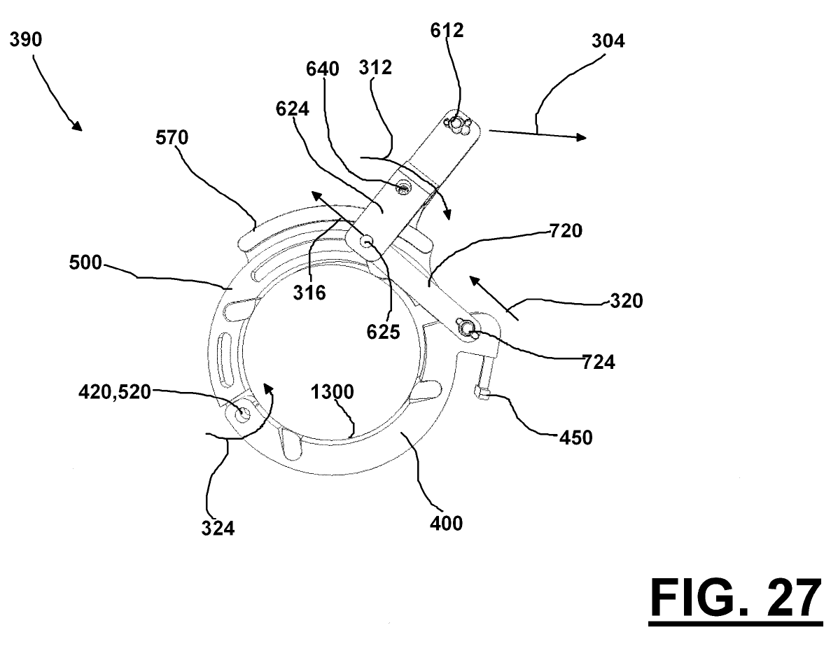

FIG. 26 is a perspective view of the drive head 390 of wrench 10 showing first 400 and second 500 sections along with the clamping/squeezing mechanism shown in a non- squeezing state, wherein the drive head 390 is positioned to tighten an item. FIG. 27 is a perspective view of the drive head 390 of wrench 10 showing the first 400 and second 500 sections along with the clamping/squeezing mechanism shown in a squeezing state and with an item 1300 to be tightened positioned in the interior of the drive head.

As indicated in FIGS. 1-5 wrench 10 can include hydraulic cylinder 1000 which houses a piston internally on a rod 1100 with the hydraulic cylinder being 1000 fluidly powered with a pair of hydraulic lines (lines are not shown for clarity but a person of ordinary skill in the art would understand the operation of a hydraulic cylinder/piston arrangement) so that as hydraulic fluid is pumped into cylinder 1000 via a first line of the pair of hydraulic lines, the piston and rod 1100 is moved outwardly from the cylinder 1000 and the arm member 550 is moved in the direction of arrow 308 thus imparting rotation to drive head 390, and as hydraulic fluid is pumped into cylinder 1000 (in the opposite direction as the first line) via a second line of the pair of hydraulic lines, the piston and rod 1100 is retracted inwardly into the cylinder 1000 and the arm member 550 is moved in the opposite direction of arrow 308 thereby resetting drive head 390 for another movement cycle.

Drive head 390 can be slideably connected to body 100 via cooperation between track 570 of second section 500, and arcuate slot 130 of body 100.

As sequentially shown in FIGS. 1-3, the extension turning mechanics of drive head 390 can occur as follows. Rod 1100 extending in the direction of arrow 304 imposes a force on first portion 610 of fulcrum lever 600 (in the direction of arrow 304) creating a turning torque on drive head 390 (in the direction of arrow 308) because fulcrum lever 600 is pivotally connected to drive head 390 through arm member 550. Rod 1100 imposing a force on first portion 610 of fulcrum lever 600 also creates a turning torque (in the direction of arrow 312) on fulcrum lever 600 about its pivot point on arm member 550 (located at opening 640), which in turn creates a pulling force on links 700,720 (in the direction of arrow 316), which in turn cause a pulling force on first section 400 (in the direction of arrow 316), which in turn causes a torsional turning torque on first section relative to second section about their pivot point 420,520 (in the direction of arrow 324). The torsional force of first section 400 relative to second section 500 (in the direction of arrow 324) along with the pulling force on first section 400 (in the direction of arrow 320) causes first section 400 to close relative to second section 500 (schematically indicated by arrows 328) causing a frictional force to be generated between an item to be loosened or tightened 1300 and drive head 390 which frictional force allows drive head 390 to actually turn item 1300 (in the direction of arrows 310) as track 570 of second section 500 moves within arcuate slot 130 of body 100 (in the direction of arrow 308).

As sequentially shown in FIGS. 4, 5, and then 1, the retraction ratcheting mechanics of drive head 390 can occur as follows. Rod 1100 retracting in the direction of arrow 304′ imposes a force on first portion 610 of fulcrum lever 600 (in the direction of arrow 304′) creating a turning torque on drive head 390 (in the direction of arrow 308′) because fulcrum lever 600 is pivotally connected to drive head 390 through arm member 550. Rod 1100 imposing such force on first portion 610 of fulcrum lever 600 also creates a turning torque (in the direction of arrow 312′) on fulcrum lever 600 about its pivot point on arm member 550 (located at opening 640), which in turn creates a pushing force on links 700,720 (in the direction of arrow 316′), which in turn cause a pushing force on first section 400 (in the direction of arrow 316′), which in turn causes a torsional turning torque on first section relative to second section about their pivot point 420,520 (in the direction of arrow 324′). The torsional force of first section 400 relative to second section 500 (in the direction of arrow 324′) along with the pushing force on first section 400 causes first section 400 to open relative to second section 500 (schematically indicated by arrows 330) minimizing any a frictional force between item to be loosened or tightened 1300 and drive head 390 which allows drive head 390 to turn relative to item 1300 (in the direction of arrow 308′) as track 570 of second section 500 moves within arcuate slot 130 of body 100—without turning item 1300 for the next extension cycle of rod 1100 (this relative movement of drive head 390 and item 1300 is called the ratcheting movement of drive head).

FIG. 2 is a side view showing rod 1100 extending in the direction of arrow 304 causing drive head 390 to enter a contracting/squeezing state thereby causing plurality of gripping inserts 490,590 to frictionally connect with item 1300, thereby causing item 1300 to turn in the direction of arrow 310 (with arrow 1310 schematically indicating a position of a point on item 1300). FIG. 3 is a side view showing rod 1100 continuing to extend in the direction of arrow 304 with drive head 390 remaining a contracting/squeezing state thereby causing plurality of gripping inserts 490,590 to remain frictionally connected with item 1300, thereby causing item 1300 to continue to turn in the direction of arrow 310 (with arrows 1310 and 1312 now schematically indicating the relative rotation of item 1300). In this manner, during an extension stroke of rod 1100 item, 1300 can be turned relatively (e.g., from arrow 1310 to arrow 1312). When rod 1100 is retracted (in the direction of arrow 304′), drive head 390 will enter an expanded state (schematically indicated by plurality of arrows 330 in FIG. 4) allowing drive head 390 to rotatively slide relative to item 1300 in the direction as arrow 308′ setting up the next extension cycle for rod 1100. In similar manner drive head 390 can ratchet back and forth over item 1300—turning item 1300 when drive head is in a contracted/squeezing state (i.e., when rod 1100 is extending in the direction of arrow 304 with squeezing/contracting schematically indicated by plurality of arrows 328 in FIG. 2), and slipping over item 1300 when drive head 390 is in an expanded state (i.e., when rod 1100 is retracting in the direction of arrow 304′ with expansion schematically indicated by plurality of arrows 330 in FIG. 4)—while the drive head 390 remains closed in both the squeezing/contracted and expanded states.

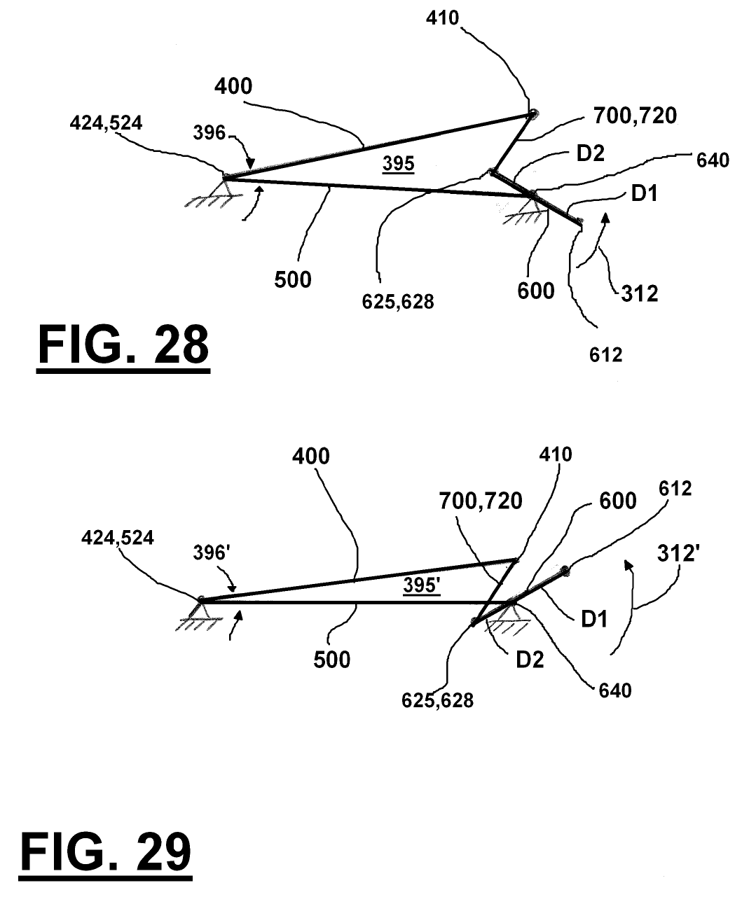

FIGS. 28 and 29 are schematic diagrams of the four bar linkage system for the squeezing drive head 390 shown respectively in expanded (FIG. 28) and squeezed or compressed (FIG. 29) states. For purposes of clarity first 400 and second 500 are shown as straight lines (instead of their actual arcuate shapes). In FIG. 28 first section 400 and second section 500 links make an angle 396. In FIG. 29, this angle is reduced to 396′ as pivot point 612 of fulcrum lever 600 is moved in the direction of arrow 312 (by extension of rod 1100 ) from FIG. 28 to FIG. 29. Similarly, retraction of rod 1100 moves pivot point 612 of fulcrum lever 612 in the opposite direction of arrow 312′ in FIG. 29 to its position shown in FIG. 28. Moving pivot point 612 from its position in FIG. 28 to its position in FIG. 29 causes first and second sections 400,500 to close in (Reducing angle 396 to angle 396′). On the other hand, moving pivot point 612 from its position shown in FIG. 29 to its position shown in FIG. 28 causes first and second sections 400,500 to open in (enlarging angle 396′ to angle 396). Such reduction and enlargement of angle 396 allows drive head 395 to clamp on and turn an item 1300 (during extension of rod 1100 ), and also unclamp and slip over (during retraction of rod 1100 ) thereby allowing drive head to ratchet back from an extended to not extended position without having to be removed from an item 1300 being turned, and without having to open up drive head 390 (i.e., drive head 390 remains a closed head during both extension and retraction of rod 1100 ).

### Force Analysis in Drive Head

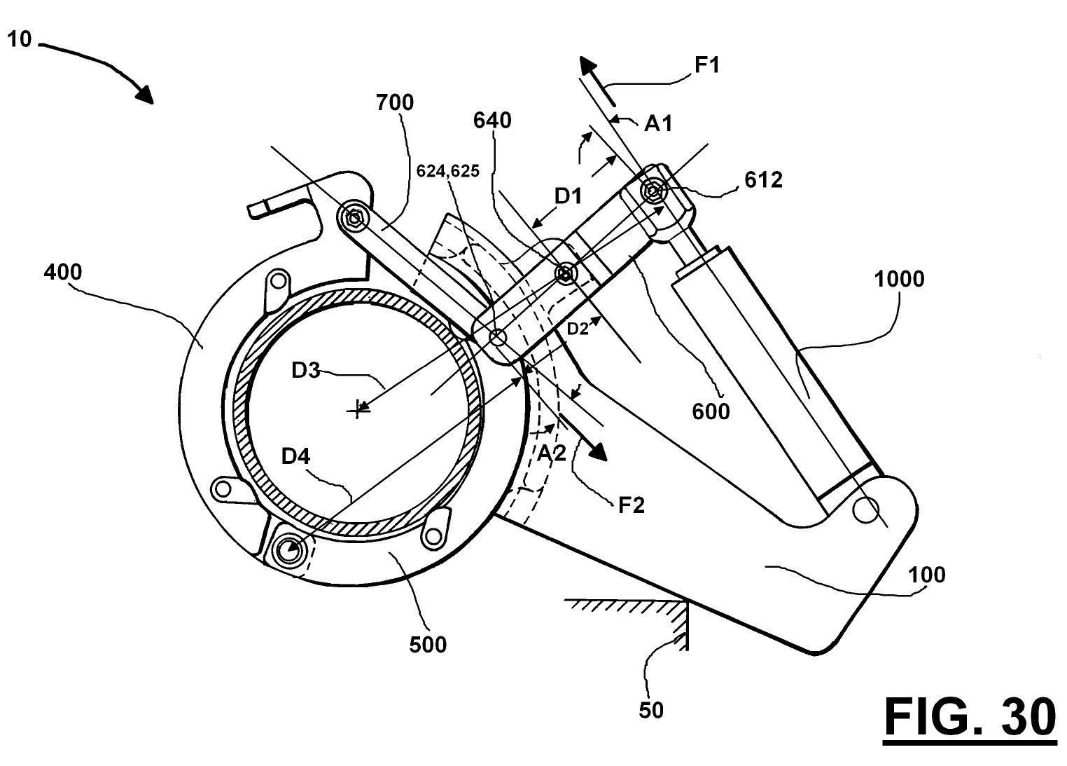

FIG. 30 is a force diagram of wrench 10. For force imposed by rod 1100 on fulcrum lever 600 at 612 is directly related to the resulting force imposed at 624,625 by fulcrum lever 600 on links 700,720 and following the following formula where:

F1=the force imposed by rod 1100 on fulcrum lever 600.

F2 is the resulting force imposed at 624,625 on links 700,720.

A1 is the angle between rod 1100 and fulcrum lever 600.

A2 is the angle between fulcrum lever 600 and links 700,720.

D1 is the distance between opening 612 and opening 640.

D2 is the distance between openings 624,625 and opening 640

F1cosign(A1)*D1=F2cosign(A2)*D2

So that

$$F 2 = \frac{F 1 cosign ( A 1 ) * D 1}{cosign ( A 2 ) * D 2}$$

During any one extension stroke of rod 1100, A1 and A2 will vary. Additionally, the ratio of D1/D2 can be varied as desired by changing the lengths of fulcrum lever 600.

The amount of turning torque applied to drive head 390 is the product of F1 times the perpendicular distance from rod 1100 to the center of rotation of drive head 390 times the frictional coefficient between the drive head and item 1300.

The amount of turning torque applied by drive head 390 to item 1300 to be loosened or tightened will be equal to the average squeezing radial force applied by drive head 390 times the frictional coefficient between drive head 390 and item 1300 to be loosened or tightened. The average squeezing radial force is equal to the F2 times the perpendicular distance between F2 and pivot point 420.

In one embodiment, during an extension stroke of rod 1100, interior space 395 of drive head 390 will attempt to contract in size. Such contraction can be caused by fulcrum lever 600 pulling on links 700,720 (such as in the direction of arrow 316) which tends to cause first link 400 to rotate relative to second link 500 in the direction of arrow 324 about pivot point 424,524.

In one embodiment, during a retraction stroke of rod 1100, interior space 395 of drive head 390 will attempt to expand in size. Such expansion can be caused by fulcrum lever 600 pushing links 700,720 (such as in the opposite direction of arrow 316) which tends to cause first section 400 to rotate relative to second section 500 in the opposite direction of arrow 324 about pivot point 424,524.

### Relative Rotation of First and Second Section in Retraction Versus Extension Modes

In one embodiment, during a retraction stroke of rod 1100, the four bar linkage mechanism of drive head 390 (formed by fulcrum 600, links 700,720; first section 400, and second section 500 form a four bar linkage system) will enter an expanding state where rotation of first section 400 relative to second section 500 about pivot point 424,524 occurs in the opposite direction of arrow 324. In one embodiment such relative expanding relative rotation between first section 400 and second section 500 is limited/restricted to a maximum extent. In one embodiment during a retraction stroke of rod 1100, the maximum amount of relative rotation between first section 400 and second section 500 in degrees is about 1, 2, 3, 4, 5, 6, 7, 8, 9, 10, 12, 14, 15, 16, 18, 20, 22, 24, 25, 26, 28, 30, 32, 34, and 35 degrees. In various embodiments the maximum amount of relative rotation is between about any two of the above specified relative degree measurements. In one embodiment before reaching any maximum amount of relative rotation between first section 400 and second section 500 (with respect to the four bar link system), the increasing reaction forces arising from fulcrum lever 600 attempting to expand first section 400 relative to second section 500 increase to such an extent that frictional forces between track 570 and arcuate slot 130 (along with possible frictional forces between first section 400 and/or second section 500 relative to item 1300) are overcome allowing drive head 390 to rotate/ratchet back into an initial starting drive position to be ready for the next extension stroke of rod 1100.

### Relative Sizes of Interior Space in Retraction Versus Extension Modes

In one embodiment, during a retraction stroke of rod 1100, the four bar linkage mechanism of drive head 390 (formed by fulcrum 600, links 700,720; first section 400, and second section 500 form a four bar linkage system) will enter an expanding state where rotation of first section 400 relative to second section 500 about pivot point 424,524 occurs in the opposite direction of arrow 324 and increases the interior space 395 of drive head 390 compared to the size of the interior space 395 during a retraction stroke. In one embodiment such relative expansion of interior space 395 is limited/restricted to a maximum extent. In one embodiment during a retraction stroke of rod 1100, the maximum amount of relative expansion of interior space during an expansion stroke in percent area (compared to the cross sectional area of interior space's 395 size during extension stroke of rod 1100 ) is about 1, 2, 3, 4, 5, 6, 7, 8, 9, 10, 12, 14, 15, 16, 18, 20, 22, 24, 25, 26, 28, 30, 32, 34, and 35 percent. In various embodiments the maximum amount of relative expansion is between about any two of the above specified relative percentages. In one embodiment before reaching any maximum amount of relative rotation between first section 400 and second section 500 (with respect to the four bar link system), the increasing reaction forces arising from fulcrum lever 600 attempting to expand first section 400 relative to second section 500 increase to such an extent that frictional forces between track 570 and arcuate slot 130 (along with possible frictional forces between first section 400 and/or second section 500 relative to item 1300) are overcome allowing drive head 390 to reset by rotating/ratcheting back into an initial starting drive position to be ready for the next extension stroke of rod 1100.

In one embodiment the cross sectional area of the interior space 395 can be defined by the area circumscribed by the interior portions of the first 400 and second 500 sections of the drive head 390. Because there may be a gap between the ends 410,510 of the interior portions of first 400 and second 500 sections of the drive head 390 (such as when in an expanded state), the area circumscribed can be determined by extrapolating the end 410 of the interior portion of the first section 400 of the drive head 390 onto the end 500 of the interior portion of the second section 500 of the drive head 390. As shown in FIG. 17 such extrapolation can be by a method of curve fitting such as using standard curve fitting (e.g., the best fit curve fit 396) considering the shape of the interior portion of the first section 400 of the drive head 390 and the shape of the interior portion of the second section 500 of the drive head 390. Alternatively a straight line 397 can be drawn between the ends of the interior portion of the first 400 and second 500 sections of the drive head 390.

### Relative Rotation of Lever Fulcrum to Drive Head in Retraction Versus Extension Modes

In one embodiment, during a retraction stroke of rod 1100, the four bar linkage mechanism of drive head 390 (formed by fulcrum 600, links 700,720; first section 400, and second section 500 form a four bar linkage system) will cause lever fulcrum 600 to rotate relative to drive head (and relative to pivot arm 550 of second section 500) causing interior area 395 of drive head to enter an expanding state, and during extension of rod 1100 lever fulcrum 600 will rotate in the opposite direction (compared to retraction of rod 1100 ) causing drive head 390 to enter a contracted state. In one embodiment the maximum sweep (relative to drive head 390) of lever fulcrum 600 during retraction and extension strokes of rod 1100 in degrees is about 1, 2, 3, 4, 5, 6, 7, 8, 9, 10, 12, 14, 15, 16, 18, 20, 22, 24, 25, 26, 28, 30, 32, 34, and 35 degrees. In various embodiments the maximum amount of relative rotation of lever fulcrum 600 is between about any two of the above specified relative degree measurements.

### Changes in Contact Area Between Drive Head and Item to be Tightened or Loosened During Extension and Retraction

In one embodiment during an extension stroke of rod 1100 drive head 390 has a maximum extension stroke area of contact with item 1300, and during a retraction stroke of rod 1100 drive head 390 has a minimum retraction stroke area of contact with item 1300. In one embodiment the maximum extension stroke area of contact is greater than the minimum retraction stroke area of contact. In various embodiments the extension stroke maximum area of contract is at least 1.1, 1.2, 1.3, 1.4, 1.5, 1.75, 2, 2.25, 2.5, 2.75, 3, 4, 5, 10, 15, 20, 25, 30, 35, 40, 45, and 50 times the retraction stroke minimum area of contact. In various embodiments the ratio of these to areas is between any two of the above specified ratio measurements.

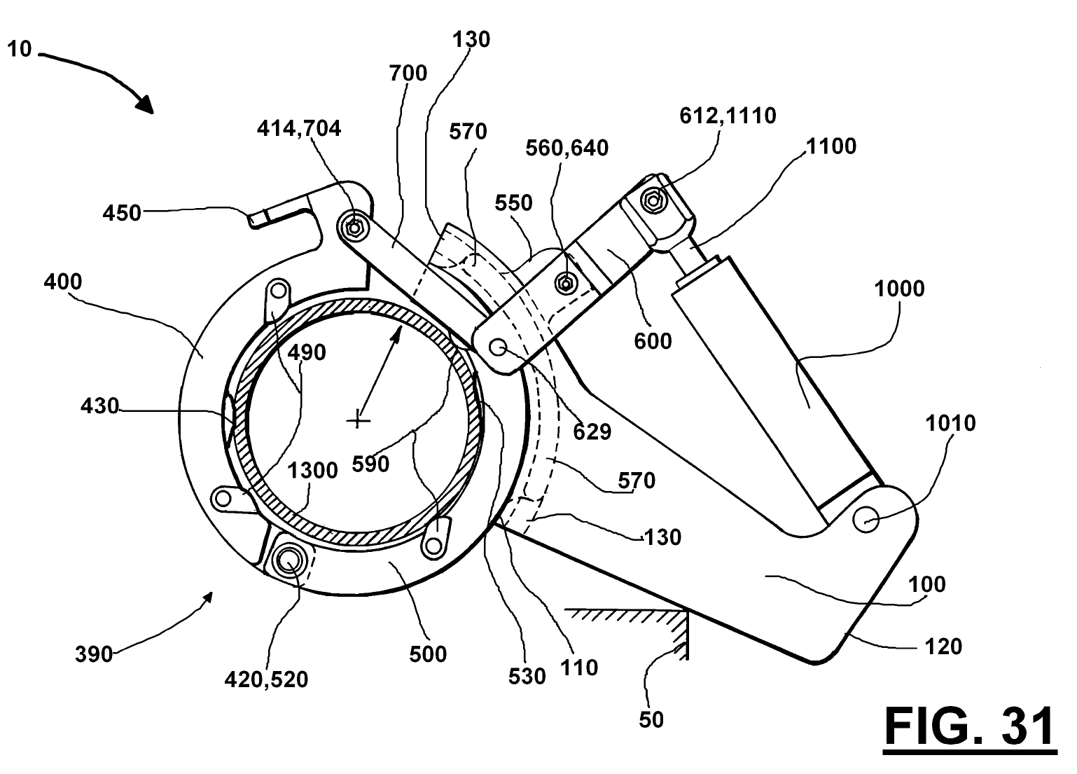

As shown in FIG. 31, in one embodiment first section 400 and/or second section 500 can include a frictionally enhancing elements 430, 530. Frictionally enhancing elements 430, 530 can be constructed of materials having high coefficients of frictions (such as rubber) and can be relatively flexible compared to the materials from which first 400 and second 500 sections are constructed. It has been found that during an initial extension stroke of rod 1100 drive head may start to slide over item 1300 before lever fulcrum 600 can cause drive head 390 to squeeze against item 1300 enough to create large frictional forces between contracting drive head 390 and item 1300. In this case frictional enhancing members 430 and/or 530 can be used to create initial frictional forces until fulcrum lever 600 can cause drive head 390 to create greater frictional forces between plurality of gripping inserts 490, 590 and item 1300. Frictional enhancing elements 430,530 are preferably flexible and can be compressed relatively easily as drive head 390 closes with an extension stroke of rod 1100.

The following is a list of reference numerals:

LIST FOR REFERENCE NUMERALS

| (Part No.) | (Description) |
|---|---|
| 10 | improved torque wrench |
| 50 | base |
| 100 | wrench body |
| 110 | first end |
| 120 | second end |
| 130 | arcuate slot |
| 300 | squeezing substantially circular head portion |
| 304 | arrow |
| 308 | arrow |
| 310 | arrow |
| 312 | arrow |
| 316 | arrow |
| 320 | arrow |
| 324 | arrow |
| 328 | arrows |
| 330 | arrows |
| 390 | drive head |
| 395 | interior space |
| 396 | first curve |
| 397 | line |
| 400 | first arcuate section |
| 410 | first end |
| 414 | opening |
| 420 | second end |
| 424 | opening |
| 430 | friction element |
| 450 | handle |
| 470 | fastener |
| 490 | plurality of gripping inserts |
| 500 | second arcuate section |
| 510 | first end |
| 520 | second end |
| 524 | opening |
| 530 | friction element |
| 550 | arm member |
| 560 | opening |
| 570 | track |
| 590 | plurality of gripping inserts |
| 600 | fulcrum lever |
| 610 | first end |
| 612 | opening |
| 620 | second end |
| 624 | prong |
| 625 | opening |
| 628 | prong |
| 629 | opening |
| 640 | opening |
| 660 | fastener |
| 670 | fastener |
| 700 | first link |
| 704 | first end |
| 708 | second end |
| 720 | second link |
| 724 | first end |
| 728 | second end |
| 750 | fastener |
| 760 | fastener |
| 762 | fastener |
| 1000 | hydraulic cylinder |
| 1010 | first end |
| 1020 | second end |
| 1030 | fastener |
| 1100 | rod |
| 1110 | first end |
| 1120 | second end |
| 1124 | arrows |
| 1200 | hydraulic line |
| 1210 | hydraulic line |
| 1300 | pipe |
| 1310 | arrow |

All measurements disclosed herein are at standard temperature and pressure, at sea level on Earth, unless indicated otherwise.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

What is claimed is:

1. An improved torque wrench system, comprising:
(a) a torque wrench body;
(b) a drive head rotatively mounted on a first end of the torque wrench body, the drive head having expanded and contracted states;
(c) a hydraulically powered cylinder mounted on the wrench body, the cylinder powering a rod between extended and retracted states, the rod being operatively connected to the drive head;
(d) wherein the rod extending from the cylinder causes the drive head to enter the contracted state and the rod retracting into the cylinder causes the drive head to enter the expanded state.

2. The torque wrench of claim 1, wherein the drive head comprises a four bar linkage system.

3. The torque wrench of claim 1, wherein the drive head comprises first and second generally acuate members, the first and second arcuate members being pivotally connected to each other and operatively connected to the rod.

4. The torque wrench of claim 3, wherein between the contracted and expanded states of the drive head, the first and second arcuate members rotate relative to each other greater than about 1 degree.

5. The torque wrench of claim 3, wherein between the contracted and expanded states of the drive head, the first and second arcuate members rotate relative to each other greater than about 2 degrees.

6. The torque wrench of claim 3, wherein between the contracted and expanded states of the drive head, the first and second arcuate members rotate relative to each other greater than about 3 degrees.

7. The torque wrench of claim 3, wherein between the contracted and expanded states of the drive head, the first and second arcuate members rotate relative to each other greater than about 10 degrees.

8. The torque wrench of claim 3, wherein between the contracted and expanded states of the drive head, the first and second arcuate members rotate relative to each other greater than about 15 degrees.

9. The torque wrench of claim 3, wherein between the contracted and expanded states of the drive head, the first and second arcuate members rotate relative to each other between about 1 and 15 degrees.

10. The torque wrench of claim 3, wherein between the contracted and expanded states of the drive head, the first and second arcuate members rotate relative to each other between about 2 and 10 degrees.

11. The torque wrench of claim 3, wherein between the contracted and expanded states of the drive head, the first and second arcuate members rotate relative to each other between about 5 and 10 degrees.

12. The torque wrench of claim 1, wherein the drive head has a minimum first cross sectional interior area in the contracted state and a maximum second cross sectional interior area in the expanded state, and the maximum interior area in the expanded state is greater than 1 percent larger than the minimum first interior area in the contracted state.

13. The torque wrench of claim 1, wherein the drive head has a minimum first cross sectional interior area in the contracted state and a maximum second cross sectional interior area in the expanded state, and the maximum interior area in the expanded state is greater than 3 percent larger than the minimum first interior area in the contracted state.

14. The torque wrench of claim 1, wherein the drive head has a minimum first cross sectional interior area in the contracted state and a maximum second cross sectional interior area in the expanded state, and the maximum interior area in the expanded state is greater than 5 percent larger than the minimum first interior area in the contracted state.

15. The torque wrench of claim 1, wherein the drive head has a minimum first cross sectional interior area in the contracted state and a maximum second cross sectional interior area in the expanded state, and the maximum interior area in the expanded state is greater than 10 percent larger than the minimum first interior area in the contracted state.

16. The torque wrench of claim 1, wherein the drive head has a minimum first cross sectional interior area in the contracted state and a maximum second cross sectional interior area in the expanded state, and the maximum interior area in the expanded state is greater than 15 percent larger than the minimum first interior area in the contracted state.

17. The torque wrench of claim 1, wherein the drive head has a minimum first cross sectional interior area in the contracted state and a maximum second cross sectional interior area in the expanded state, and the maximum interior area in the expanded state is between 1 and 15 percent larger than the minimum first interior area in the contracted state.

18. The torque wrench of claim 1, wherein the drive head has a minimum first cross sectional interior area in the contracted state and a maximum second cross sectional interior area in the expanded state, and the maximum interior area in the expanded state is between 5 and 15 percent larger than the minimum first interior area in the contracted state.

19. The torque wrench of claim 3, wherein a fulcrum lever operatively connects the rod to the first and second arcuate sections, and between the contracted and expanded states of the drive head, the fulcrum lever rotates relative to the second arcuate section between about 1 and 15 degrees.

20. The torque wrench of claim 3, wherein a fulcrum lever operatively connects the rod to the first and second arcuate sections, and between the contracted and expanded states of the drive head, the fulcrum lever rotates relative to the second arcuate section between about 5 and 15 degrees.

21. An improved torque wrench system, comprising:
(a) a torque body;
(b) a drive head rotationally connected to the torque body;
(c) a fluid cylinder operatively connected to the drive head and the torque body;
(d) with the drive head having a relaxed state with an opening of a first size, for fitting over an item to be tightened or loosened such as a joint of tubing or pipe,
(e) wherein the fluid cylinder during the process of causing rotation of the drive head in a first direction causes the drive head to enter a squeezing state wherein the opening reduces to a second size which is smaller than the first size, thereby causing frictional forces between the drive head and the item to be tightened or loosened during turning in the first direction, and
(f) wherein the fluid cylinder in the process of causing rotation of the drive head in a second direction, which second direction is the opposite direction of the first direction, causes the drive head to enter a relaxed state wherein the frictional forces between the drive head and the item to be tightened or loosened are substantially reduced in relation to the frictional forces generated during the squeezing state.

22. An improved torque wrench system, comprising:
(a) a torque body;
(b) a drive head rotationally connected to the torque body;
(c) a fluid cylinder operatively connected to the drive head and the torque body;
(d) with the drive head having a relaxed state with an opening of a first size, for fitting over an item to be tightened or loosened such as a joint of tubing or pipe,
(e) wherein the fluid cylinder during the process of causing rotation of the drive head in a first direction causes the drive head to enter a squeezing state wherein the opening reduces to a second size which is smaller than the first size, thereby causing frictional forces between the drive head and the item to be tightened or loosened during turning in the first direction, and
(f) wherein the fluid cylinder in the process of causing rotation of the drive head in a second direction, which second direction is the opposite direction of the first direction, causes the drive head to enter a relaxed state wherein the opening is of a larger size than the second size.
